(19) United States
(12) Patent Application Publication
(10) Pub. No.: US 2010/0234154 A1
(43) Pub. Date: Sep. 16, 2010

(54) APPARATUS FOR GUIDING A CHAIN

(76) Inventor: Jochen Klieber, Tacherting (DE)

Correspondence Address: HISCOCK & BARCLAY, LLP, 2000 HSBC PLAZA, 100 Chestnut Street, ROCHESTER, NY, 14604-2404, US

(21) Appl. No.: 12/724,022

(22) Filed: Mar. 15, 2010

(30) Foreign Application Priority Data
Mar. 16, 2009 (DE) 102009013339.9

(51) Int. Cl. B62J 13/00; B62M 9/12; F16H 7/18

(52) U.S. Cl. 474/80; 474/144; 474/140

(57) ABSTRACT

The invention relates to the guidance of chains on bicycles. In this context, a chain stay is provided on a rear section of a bicycle, which chain stay is set up by means of a receiving device in such a manner that a chain guide can be fixed firmly on the chain stay. Furthermore, the chain guide is designed in such a manner that with regard to the guidance of the chain, it is possible to respond to a lateral position change of the chain due to a derailleur gear in such a manner that the desired guidance of the chain is achieved in any lateral position of the chain. The chain is thus held in the desired position in any operating state.

### FIELD OF THE INVENTION

The invention relates to the chain guide on bicycles. In particular, the invention relates to a chain stay on a bicycle rear section, a chain guide, a chain guide system and a bicycle.

### TECHNOLOGICAL BACKGROUND

The drive chain of a bicycle can be exposed to appreciable vibrations in all-terrain usage, for example, on a mountain bike. This can cause the bicycle chain to jump off the chain wheel or the sprocket. However, this possible sudden change in position of the chain is dangerous and therefore undesirable. Known chain guide technologies use components which are fixed firmly on the bottom bracket of the bicycle frame.

At the same time, a chain guide is also subjected to the technical problem that the chain is tensioned to different amounts in different gears. A chain guide can therefore also be used partially for tensioning the chain. Furthermore, a movable rear section of full-suspension bicycle frames poses an additional challenge on the guidance of the chain since the chain also executes a movement when operating during suspension of the rear section.

### SUMMARY OF THE INVENTION

It is an object of the invention to provide an improved guidance of a chain on a bicycle.

A chain stay on a bicycle rear section, a chain guide, a chain guide system comprising a chain stay and a chain guide and a bicycle having a rear section with a chain stay are specified according to the features of the independent claims. Further developments of the invention are obtained from the dependent claims.

The exemplary embodiments described relate equally to the chain stay, the chain guide, the chain guide system and the bicycle.

### DEFINITIONS AND EXPLANATIONS OF TERMS

It should be pointed out that in the context of the invention, the term “chain guide” comprises any device which during a forward movement of the chain and also during a backward movement of the chain, is capable of holding the chain in position along a lateral direction in such a manner that no undesired gear changes or position changes of the chain take place.

Furthermore, in the context of the present invention, unless defined otherwise, a “lateral direction” is defined as being perpendicular to the direction of the drive movement of the chain. In the figures, this is designated by y-direction.

The “roller element” in the context of the invention, for example, comprises one or more switching rollers or another mechanical unit which ensures the guidance of the chain.

The term “receiving device” is defined in the context of the invention as a region of the chain stay which is designed for fastening a chain guide on the chain stay. For example, the receiving device can be specially shaped and comprise a guide element and/or a bore by which means the fastening can be effected. If desired, the receiving device can also be designed merely as a bore and/or as a thread.

According to one exemplary embodiment of the invention, a chain stay is provided on a bicycle rear section, wherein the chain stay comprises at least one receiving device. In this context, the chain stay extends between a bottom bracket casing of the bicycle and a region of a rear dropout of the bicycle. Furthermore, the receiving device is part of the chain stay and the receiving device is designed for fastening a chain guide on the chain stay.

In this context, it should be explicitly pointed out that the region of the chain stay in which the receiving device is located does not comprise the rear dropout. In other words, this comprises a receiving device which is placed clearly at a distance from the rear dropout.

In this context, the receiving device can be designed in such a manner that following an attachment of the chain guide to the chain stay, a minimum distance between the element of the chain guide which guides the chain, such as a chain guide device, for example a roller element or a sliding element, and the chain stay comprises a minimal distance. This minimal distance can, for example, be the height of the chain or a chain member which in exemplary cases is 4 mm. However, other distances and heights are also possible.

For example, the sliding element, that can also be referred to as a glide element, can be configured to be saddle-shaped in such a manner that the chain rests on the saddle, or contacts the saddle, and during a pedalling movement slides or glides along the saddle, the sliding element being configured in such a manner that during lateral movements of the chain caused by a derailleur gear, the chain is held or guided by the sliding element within a desired positional range.

The sliding element can have a continuous surface which, in the mounted state when the bicycle is upright, runs horizontally in the lateral direction, i.e. in the Y direction or perpendicular to the direction of tension of the chain.

According to a further embodiment, the sliding element has a surface which, in the mounted state when the bicycle is upright, runs at an inclination in the lateral direction, i.e. in the Y direction or perpendicular to the direction of tension of the chain.

According to a further embodiment, the sliding element has a surface which is configured with shoulders or steps, wherein the steps can be configured to be horizontal and/or inclined. For example, three steps can be provided. For example, the three steps are configured to be horizontal. In another example, the steps are all configured to be inclined, wherein the inclination can be configured to be the same or of varying extent. In another example, the middle step is configured to be horizontal and the two outer steps are configured to have the same or different inclination. In any case, a gradation can be configured to be the same or different. Intermediate steps are also possible to support a change of the chain from one partial region to the next.

The sliding surface, whether stepped or not, whether inclined or not, is preferably configured in such a manner that the chain is guided as far as possible in a region which corresponds with the respective front chain wheel used.

The, in relation to the direction of tension of the chain, front and rear edge regions of the sliding element are configured in such a manner that the frictional resistance and the risk of the chain being entangled or jammed are minimised.

The sliding element preferably has a low-friction surface for the chain which is at the same time insensitive to dirt and moisture. The surface is preferably disposed on a supporting element and can easily be exchanged.

At the same time, in this and in any other exemplary embodiment of the invention, the roller element can be designed to be one-piece or multi-piece. Furthermore, the roller element can have various discrete diameters, but also a conical shape of the roller element which therefore provides continuously different diameters in a certain range is also possible. In this case, the roller element can be designed, for example, as an SGS roller which, for example, has three different diameters, wherein the first diameter comprises 12 teeth, the second diameter comprises 11 teeth and the third diameter comprises 10 teeth. However, other tooth distributions over the roller element are also possible.

It is explicitly noted that the function of the chain guide in the context of the invention is always described in the fastened state on the chain stay unless indicated differently.

In this context, the receiving device can, for example, be a hole, a thread, a click closure or another device which allows the attachment and fixing of a chain guide directly on the chain stay.

By the attachment and fixing of the chain guide on the chain stay according to the invention, it can advantageously be achieved that in the case of a spring-mounted rear section of the bicycle, the distance between the chain guide and the chain can be kept constant or almost constant even during a suspension of the rear section. This is made possible by the direct fixing of the chain guide on the chain stay which as part of the rear section also moves during such a movement. In other words, the guidance of the chain which is achieved by the invention is capable of determining and/or holding the lateral position of the chain at any time during a movement of the rear section since a physical contact between the chain guide and the chain is still made even at these times.

At the same time, the receiving device can be disposed, for example in a region which is disposed very close to the bottom bracket of the bicycle. For example, the distance can be less than 12 cm, less than 10 cm, less than 8 cm or less than 6 cm. As a result of the close positioning of the chain guide on the chain stay to the bottom bracket, the entire chain guide is disposed in a protected position since it is protected by the chain stay on the one hand and by the chain wheels on the other hand. This can lead to the advantageous avoidance of mechanical damage to the chain guide. However, other distances are also possible if desired.

In this case of placing the receiving device close to the bottom bracket, it is of further advantage that, for example, when back-pedalling the bicycle the chain can be held very precisely at the position on the desired chain wheel. This occurs since the distance from the chain guide to the chain wheels is specifically selected to be very minimal. In other words, on the short section between the chain guide and the position at which the chain again makes physical contact with the chain wheels, it is not possible for the chain to experience such a large lateral deflection that an undesirable position change of the chain on the chain wheels takes place. In other words, the chain is held by the chain guide and the chain stay according to the invention in the desired position on the chain wheels even during a backward movement of the chain. In this case, the desired position on the chain wheels usually corresponds to the position which is selected by the user by means of a front derailleur.

For example, the receiving device can be disposed as a hole and/or thread on the underside of the chain stay in the front region near the bottom bracket. However, an arrangement of the receiving device in the central region of the chain stay between the first end of the chain stay on the bottom bracket and the second end of the chain stay in the rear region of the dropout is also possible. In this case, for example, a bore and/or a thread can be disposed on the upper side of the chain stay in the central region, at which hole for example a casing for the chain guide can be attached. This casing can, for example, contain an axis of rotation with a pivot arm, on which pivot arm a roller element, for example, is attached. In this context, the casing, the axis of rotation, the pivot arm and the roller element can be construed as a chain guide. This possibility for designing a chain guide is described subsequently more accurately in FIGS. 22 and 23.

It should furthermore be considered to be an advantage of the invention that the chain guide is not attached behind the chain wheels on the bottom bracket casing. The invention thus avoids an additional dismounting of the chain wheels when attaching the chain guide. This can mean both time when installing the chain guide and also incorrect mountings on the chain wheels can be prevented.

At the same time, in this and every exemplary embodiment of the invention, the chain stay can be part of a lever of a suspended rear wheel frame which can be designed to be both one-piece and also multi-piece.

If desired, the receiving device can be designed as a single thread. In contrast to known technologies, according to this exemplary embodiment of the invention, a fastening means is sufficient to fasten the chain guide on the chain stay.

According to a further exemplary embodiment of the invention, the receiving device is designed in such a manner that when fastening the chain guide on the chain stay, a guidance of the chain is effected during a movement of the chain caused by a derailleur gear.

In other words, the chain guide is capable of providing guidance of the chain at different lateral positions and at positions of different heights of the chain.

It is furthermore noted that this movement can comprise a movement which takes place two-dimensionally, in each case perpendicularly to the main direction of movement of the chain. That is, firstly a lateral sideward movement of the chain and secondly a movement of the chain towards a different height. These positional and directional designations will be defined and illustrated subsequently in the figures.

At the same time, in the context of the invention the term derailleur gear is to be understood as a gear change which can be brought about by a front derailleur and also by a rear derailleur on a bicycle.

According to this exemplary embodiment, the chain guide can be designed, for example, as a pivotable arm which is capable of compensating for or co-executing lateral movements of the chain in relation to its drive direction. In other words, the receiving device of this exemplary embodiment allows a chain guide which can respond dynamically to the derailleur gear process.

According to a further exemplary embodiment of the invention, the receiving device is designed for receiving the chain guide in a form-fitting manner during fastening of the chain guide.

At the same time, an at least partially form-fitting hold is possible. At the same time, the chain guide can comprise, for example, a connecting element and a roller element, the roller element making the physical contact and therefore providing the guidance of the chain and the connecting element being designed for attachment to the receiving device. At the same time, the connecting element can, for example, comprise a saddle, an elevation, a recess and/or another surface which achieves a form-fitting or positive or a partially positive connection to the receiving device.

According to a further exemplary embodiment of the invention, the sliding element produces the physical contact and therefore the guidance of the chain, a connecting element being provided for attachment to the receiving device. In any case, for example, the connecting element can comprise a saddle, an elevation, a recess and/or another surface which makes a form-fitting or positive respectively or a partially positive connection with the receiving device.

According to a further exemplary embodiment of the invention, the receiving device is disposed on an underside of the chain stay.

This exemplary embodiment of the invention can allow a secure arrangement of the chain guide in the protected region between the chain wheels and the chain stay when placing the receiving device in the front chain stay near the bottom bracket.

According to a further exemplary embodiment of the invention, the receiving device comprises a guide element and at least one bore, wherein the guide element makes it possible to push the chain guide onto the chain stay and wherein the bore makes it possible to fix the chain guide in a pushed-on state.

At the same time, the guide element can be designed, for example, as a guide rail.

In other words, a method in which, in a first step, the chain guide is pushed onto the chain stay with its receiving device and its guide element corresponds to this exemplary embodiment of the invention. In a second step, the chain guide is fixed, for example by fastening means such as a screw in the bore which can also be executed as a thread. At the same time, this guide element can be specifically designed in combination with the chain guide to be attached in such a manner that a form-locking fit or tight fit is obtained between the guide element of the receiving device and the chain guide. For example, a connecting element of the chain guide can have a surface which is adapted to the surface of the guide element in such a manner that a form-locking fit is obtained. It is also possible that an intermediate plate which is also part of the chain guide is inserted between the connecting element and the receiving device to produce a form-locking fit. In this case, the intermediate plate functions as an adapter.

According to a further exemplary embodiment of the invention, the guide element allows a two-dimensional alignment of the chain guide when fastening the chain guide.

For example, the chain guide can comprise a connecting element and an intermediate plate as well as a roller element or sliding element. At the same time, the form and dimensioning of the guide element on the chain stay can be designed in such a manner that the chain guide to be attached can be moved in a two-dimensional manner before fixing in order to make a fine adjustment of the chain guide. This may provide an easier and more precise installation of the chain guide.

According to a further exemplary embodiment of the invention, a first distance between the receiving device and the bottom bracket casing is smaller than a second distance between a rear wheel and the bottom bracket casing.

In other words, the receiving device is positioned close to the bottom bracket casing in such a manner that the advantages of this positioning described above are obtained for the chain guide.

At the same time, the receiving device can be located in particular on the underside of the chain stay. With this exemplary embodiment it can be achieved that the chain guide merely makes physical contact with the chain stay on the underside with the chain stay. Thus, a partial encasing of the chain guide can be avoided as would be the case, for example, with a clamp-like design. In this region, which is very close to the bottom bracket, there is usually very little space between the chain stay and the rear wheel. As a result of the receiving device according to the invention on the underside of the chain stay on which the chain guide can be screwed, for example, this exemplary embodiment of the invention avoids projecting into this already very narrow region on the inner side of the chain stay. This can therefore avoid any damage to the rear wheel by the chain guide and any damage to the chain guide by the rear wheel.

According to a further exemplary embodiment of the invention, the receiving device is disposed in a central region of the chain stay between the bottom bracket casing of the bicycle and the region of a rear dropout.

Since more space between the chain stay and the rear wheel is provided in this region of the chain stay, it is also possible to use a chain guide which uses a clamp-like encasing of the chain stay in this region. In this exemplary embodiment of the invention, for example, a pivotable arm of the chain guide can be used, which can co-execute movements of the chain caused by derailleur gears.

According to a further exemplary embodiment of the invention, there is provided a chain guide for guiding a bicycle chain and for attachment to a chain stay on a bicycle rear section. For example, the chain guide comprises a chain guiding device which is configured in such a manner that during movements of the chain caused by a derailleur gear, the chain is guided by the chain guiding device.

According to a further exemplary embodiment of the invention, the chain guide comprises a sliding element which is configured in such a manner that during movements of the chain caused by a derailleur gear, a chain is held within a desired positional range by the sliding element.

For example, the sliding element is configured to be saddle-shaped in such a manner that the chain rests on the saddle or contacts the saddle and during a pedalling movement slides along the saddle, the sliding element being configured in such a manner that during lateral movements of the chain caused by a derailleur gear, the chain is held or guided by the sliding element within a desired positional range.

According to another exemplary embodiment of the invention, the chain guide comprises a roller element, wherein the roller element has at least one first region having a first diameter and a second region having a second diameter. The first and the second diameters are different and the first region is designed for guidance of the chain in a first position of the chain on chain wheels of the bicycle and the second region is designed for guidance of the chain in a second position of the chain on the chain wheels of the bicycle. In addition, a change of the chain from the first into the second position is caused by a derailleur gear.

This exemplary embodiment of the invention has the advantage that in every position of the chain before and after a gear change, physical contact is always maintained between the chain guide, for example, the roller element and the chain. This means considerable riding comfort and surefootedness for the user.

It is furthermore possible that the chain guide is designed as a parallelogram, the guidance of the chain during a movement of the chain caused by a derailleur gear being effected by a movement of the parallelogram; and wherein angles inside the parallelogram are varied during the movement of the parallelogram.

According to a further exemplary embodiment of the invention, there is provided a chain guide system comprising a chain stay according to any one of the preceding exemplary embodiments. Furthermore, the chain guide system comprises a chain guide for guiding a chain, wherein the chain guide comprises a chain guiding device which is configured in such a manner that during movements of the chain caused by a derailleur gear, the chain is guided by the chain guiding device.

According to a further exemplary embodiment of the invention, the chain guide comprises a sliding element which is configured in such a manner that during movements of the chain caused by a derailleur gear, a chain is held within a desired positional range by the sliding element.

According to a further exemplary embodiment of the invention, the chain guide comprises a roller element. At the same time, the roller element is designed in such a manner that during movements of the chain caused by a derailleur gear, the chain is held in a desired position by the roller element.

It is again explicitly noted that the exemplary embodiments and advantages of the invention described so far relate equally to the chain guide, the chain guide system and the bicycle.

According to a further exemplary embodiment of the invention, there is provided a chain guide system, wherein the roller element has at least one first region having a first diameter and a second region having a second diameter, wherein the first and the second diameters are different and wherein the first region is designed for guidance of the chain in a first position of the chain on chain wheels of the bicycle and wherein the second region is designed for guidance of the chain in a second position of the chain on the chain wheels of the bicycle. Furthermore, a change of the chain from the first into the second position is caused by a derailleur gear.

According to a further exemplary embodiment of the invention, the different diameters of the roller element are adapted to diameters of the chain wheels of the bicycle in such a manner that a variation of a wrap-around angle of the chain around the roller element is minimised in the event of changes in the position of the chain on the chain wheels.

According to a further exemplary embodiment of the invention, the sliding element comprises a surface which runs at an inclination in such a manner that the direction of inclination is adapted to the different diameters of the front chain wheels so that any variation of a wraparound angle of the chain around the roller element accompanying changes in the position of the chain on the chain wheels is minimised.

In other words, the roller element has two different diameters when two chain wheels are present and three different diameters when three chain wheels are present. However, a deviation from this is also possible. In other words, the chain guide is designed in its provision of different diameters and the receiving device in such a manner that when the chain is positioned in a first position on the largest chain wheel, it rests on the chain guide or the roller element in the first region having a first small diameter, when the chain is positioned on the central chain wheel, the chain rests on the second region having an average diameter of the roller element and when the chain is positioned on the smallest chain wheel, the chain rests on the roller element in a third region having the largest diameter of the roller element. Due to this construction which can deduced for example from the subsequent FIGS. 1, 2, 3 and FIGS. 14 to 16, it can be achieved that the wrap-around angle of the chain around the roller element does not experience any major variations or no variation respectively when the chain is shifted to different positions on the chain wheels.

In other words, as a result of the different diameters of the roller element, a maximisation of the wrap-around angle between the chain and the roller element is achieved in the different positions which the chain adopts in different gears. This not only relates to position changes of the chain during a change from one to another chain wheel but also to position changes made by the chain as a result of gear changes at the rear derailleur.

This has the advantage that in every position of the chain before and after a gear change, physical contact is always maintained between the chain guide, for example, the roller element and the chain. This means considerable riding comfort and surefootedness for the user.

According to a further exemplary embodiment of the invention, the roller element has three different diameters, wherein in each case one diameter of the roller element corresponds to respectively one position of the chain on one of three chain wheels.

According to a further exemplary embodiment of the invention, the chain guide has a pivot joint, wherein the guidance of the chain during a movement of the chain caused by a derailleur gear is effected by a movement of the chain guide around the pivot joint.

In other words, the receiving device in combination with this chain guide is designed in such a manner that when fastening the chain guide on the chain stay, a guidance of the chain is effected during a movement of the chain caused by a derailleur gear.

As will be described in further detail for example in the following FIGS. 22 and 23, this exemplary embodiment of the invention can be executed by means of mechanical elements which allow a lateral movement and thus during a lateral movement of the chain during or after a gear change, follow this movement and therefore guide the chain in a broad lateral region as desired.

According to a further exemplary embodiment of the invention, the pivot joint comprises an axis of rotation and the chain guide comprises a pivotable arm. In addition, a roller element is attached to the arm, wherein the guidance of the chain during a movement of the chain caused by a derailleur gear is effected by a pivoting movement of the arm.

According to a further exemplary embodiment of the invention, there is provided a bicycle having a rear section on which a chain stay according to any one of the preceding exemplary embodiments is provided.

According to a further exemplary embodiment of the invention, there is provided a bicycle on which a chain guide according to any one of the preceding exemplary embodiments can be mounted on a chain stay according to any one of the preceding exemplary embodiments.

According to a further exemplary embodiment of the invention, there is provided a bicycle on which a chain guide according to any one of the preceding exemplary embodiments is mounted on a chain stay according to any one of the preceding exemplary embodiments.

In addition, it is pointed out that “comprising” and “having” does not exclude any other elements or steps and “one” or “a” does not exclude a plurality. It should also be noted that features or steps which have been described with reference to one of the above exemplary embodiments can also be used in combination with other features or steps of other exemplary embodiments described above. Reference numerals in the claims should not be regarded as a restriction.

Preferred exemplary embodiments of the invention are described hereinafter with reference to the figures.

### BRIEF DESCRIPTION OF THE FIGURES

FIG. 1 shows a schematic two-dimensional diagram of a chain stay of a chain guide according to an exemplary embodiment of the invention.

FIG. 2 shows a schematic two-dimensional diagram of a chain stay in bird's eye view according to an exemplary embodiment of the invention.

FIG. 3 shows a schematic two-dimensional diagram of a chain stay with a chain guide according to an exemplary embodiment of the invention.

FIG. 4 shows a schematic two-dimensional diagram of a chain stay with a chain guide according to an exemplary embodiment of the invention.

FIG. 5 shows a schematic two-dimensional view of a chain stay with a chain guide according to a further exemplary embodiment of the invention.

FIG. 6 shows the chain guide from FIG. 5 in a sectional view.

FIG. 7 shows a schematic two-dimensional diagram of a part of a chain stay with a receiving device according to an exemplary embodiment of the invention.

FIG. 8 shows a schematic two-dimensional diagram of a guide plate for fastening a chain guide on a chain stay according to an exemplary embodiment of the invention.

FIGS. 9 to 13 show schematic two-dimensional diagrams of a connecting element of a chain guide for fastening to a chain stay according to different exemplary embodiments of the invention.

FIGS. 14 to 16 show schematic two-dimensional diagrams of a roller element as part of a chain guide system according to an exemplary embodiment of the invention.

FIGS. 17 to 20 show schematic two-dimensional diagrams of an intermediate plate as part of a chain guide system according to an exemplary embodiment of the invention.

FIG. 21 shows a schematic two-dimensional diagram of a bicycle having a chain stay according to an exemplary embodiment of the invention.

FIGS. 22 and 23 show schematic two-dimensional diagrams of a chain stay according to different exemplary embodiments of the invention.

In the following descriptions of the figures, the same reference numerals are used for the same or similar elements.

The diagrams in the figures are schematic and not to scale.

### DETAILED DESCRIPTION OF EXEMPLARY EMBODIMENTS

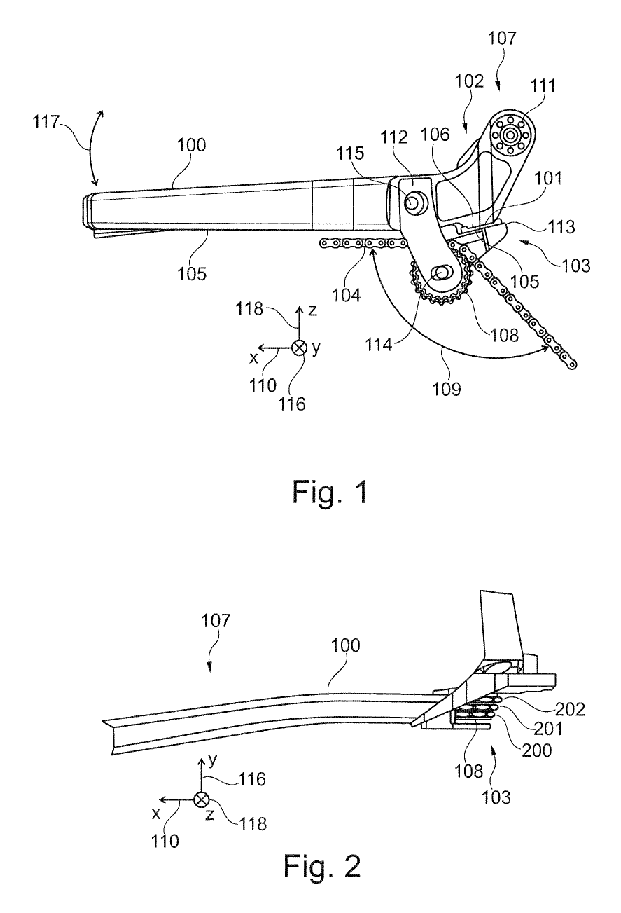

FIG. 1 shows a chain stay 100 on a bicycle rear section, wherein the chain stay comprises at least one receiving device 101. The chain stay extends between the bottom bracket casing of the bicycle and a region of a rear dropout of the bicycle. In this case, the receiving device is part of the chain stay itself. In other words, the receiving device is an integral part of the chain stay. Furthermore, the receiving device is designed for fastening a chain guide 103 on the chain stay. Also shown is a front region 102 of the chain stay in which the swing arm bearing 111 is also shown alongside the chain guide 103. In other words, this comprises a chain stay of a suspended rear section of the bicycle.

At the same time, in the context of the present invention as long this is not explicitly defined differently, the terms “in front of” and “behind” or “front regions” and “rear regions” are specified with reference to the x coordinate axis 110. Consequently, the x axis has increasingly larger values from right to left and large x values describe the rear region of the chain stay, whilst smaller x values describe the front region. In the diagram shown rear regions are therefore located in the left region of FIG. 1 whilst front regions of the chain stay are located in the right part of FIG. 1.

It can be clearly seen that the chain 104 moves parallel to the chain stay along the x axis during a pedalling movement of the user. Also shown is the y axis 116 which is depicted schematically. This y axis 116 stands perpendicularly on the plane of FIG. 1 shown. This y axis therefore describes movements of the chain in the lateral direction. Additionally shown is the z axis 118 which gives different heights of the chain, for example, when the chain changes its position due to a shift of the chain (derailleur gear).

The receiving device 101 is designed, for example, in such a manner that when fastening the chain guide to the chain stay, a guidance of the chain (104) is effected during a movement of the chain caused by a derailleur gear.

The chain guide system 107 shown therefore comprises the chain stay 100 and the chain guide 103 for guiding the chain. At the same time, the chain guide in turn comprises a roller element 108 as a chain guiding device which roller element can be designed in one piece or as multi-piece. In this case, the roller element is designed in such a manner that during movements of the chain caused by a derailleur gear, the chain is held by the roller element in a desired position in the y direction and/or in desired heights in the z direction.

At the same time, the exemplary embodiment of the chain guide shown here further comprises a connecting element 113 which connecting element is designed both for receiving and fixing the roller element 108 and also for attachment to the receiving device 101. In this exemplary embodiment, the receiving device 101 is an integral component of the chain stay which receiving device provides a guide element 106. The guide element can be designed, for example, as a guide rail having a cubic or non-cubic external shape.

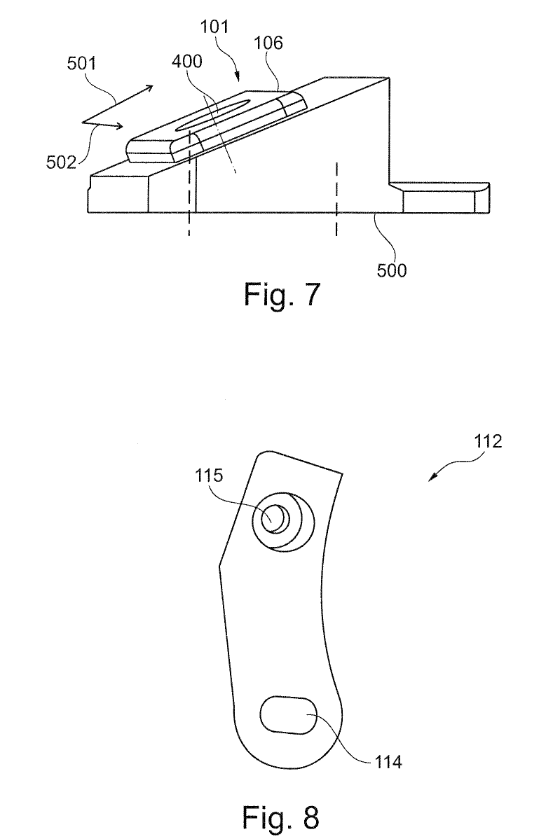

The receiving device 101 is therefore the region of the chain stay which has a bore which cannot be seen in FIG. 1 (but in FIGS. 4 and 7). By means of the bore the connecting element 113 of the chain guide 103 can be fixed on the chain stay 100, for example, by a screw. In this context, it is explicitly noted that a specific and detailed embodiment of the guide element 106 of the receiving device is described in the following FIG. 7.

FIG. 1 further shows a chain guide 103 having a guide plate 112 which has openings 114 and 115 for different fixing purposes. The roller element 108 which, for example, can provide different diameters for the chain guide, can be fixed at the opening 114. As a result of the opening 115, the guide plate and therefore the chain guide 103 can be fixed on the outer side of the chain stay 100. For example, in a first step it is possible to align the chain guide 103 and, for example, to orient the chain guide 103 at the correct angle for positioning and alignment of the connecting element 113 on the guide element 106 of the chain stay and in a second step to fix the chain guide 103 in the region of the guide element 106 by means of, for example, a screw connection in the bore (not shown). However, a fixing by means of a screw connection at the opening 115 is also possible.

However, in this and any exemplary embodiment of the invention, the chain stay can be part of a lever of a suspended rear wheel frame which can be designed to be both one-piece and multi-piece.

Also shown is the wrap-around angle 109 which describes the wrapping of the chain 104 around the roller element 108. The smaller the wrap-around angle 109, the larger is the bearing surface on the roller element and correspondingly larger is the desired guidance of the chain in the lateral y direction 116 as well as possibly also in the main direction of movement of the chain x 100.

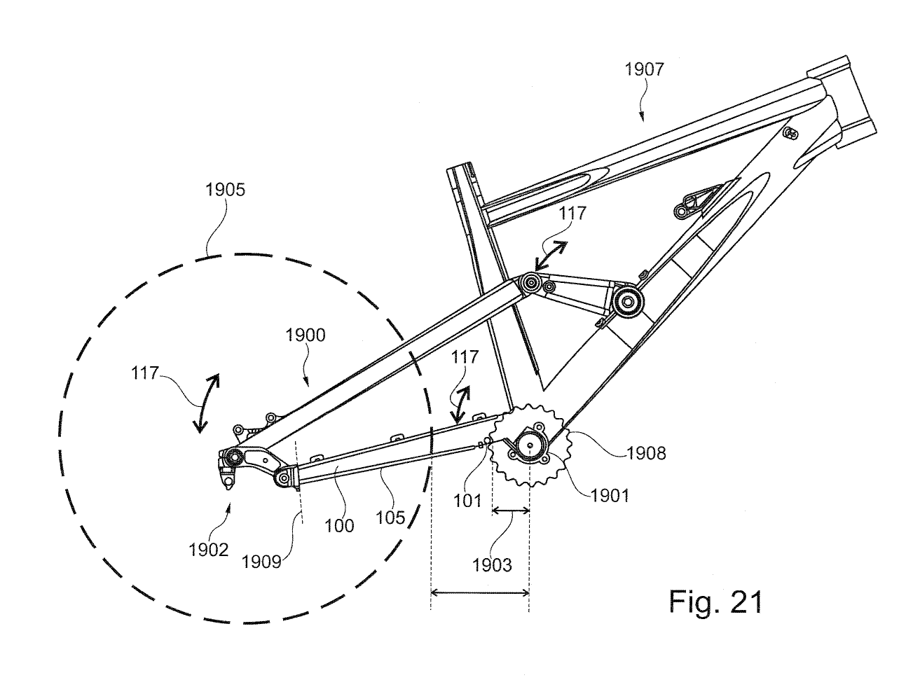

In this context, it should be explicitly noted that the right front part 102 of the chain stay 100 directly adjoins the region of the bottom bracket of the bicycle (not shown). This will be shown and described in detail and clearly in the following FIG. 21. The attachment of the chain guide 113 on the underside of the chain stay 105 on the receiving device 101 in this region very close to the bottom bracket may mean various advantages for the user of the bicycle. For example, in this front region 102 the chain guide 103 is disposed in a region which is located between the chain stay 100 and the chain wheels (not shown). The chain guide 103 is therefore better protected from mechanical influences. Furthermore, during a movement of the rear section which is indicated by the arrow 117 and which is made possible, for example, as a result of the swing arm bearing 111, it is given that the distance between the chain 104 and the roller element 108 for guiding the chain only varies minimally or does not vary at all. This means an improved guidance of the chain in situations in which movements of the rear section are caused due to unevennesses of the terrain.

In other words, the exemplary embodiment of the invention from FIG. 2 is able to keep the distance of the roller from the chain stay constant and permanent contact of chain and roller is provided regardless of the dynamics of the rear section.

Likewise, as a result of this arrangement of the chain guide 103 near this bottom bracket, it is ensured that, for example, during a back pedalling whilst riding, the chain does not fall off from the chain wheels since the distance between the roller element 108 and the chain wheels is minimised. In other words, the chain guide system 107 shown is also able to guide the chain 104 during back pedalling in such a manner that an undesirable gear change takes place on the chain wheels.

FIG. 2 shows the stay 100 of the chain guide system 107 from FIG. 1 in a plan view. In this case, it can be clearly seen that the roller element 108 comprises a first region 200 having a first diameter and a second region 201 having a second diameter. In this case, the two diameters are different. Also shown is a third region 202 which likewise has a diameter different from the first two diameters. The first region 200 is designed for guiding the chain in a first position of the chain on the chain wheels and the second region is designed for guiding the chain in a second position of the chain on the chain wheels of the bicycle. At any time, the roller element is adapted in its three diameters to the chain wheels in such a manner that a change of the chain from the first into the second position or from the second into the third position is caused by a derailleur gear.

In other words, the three regions 200, 201 and 202 each correspond to one position of the chain on the chain wheels.

In other words, the chain guide 103 is able to guide the chain with the advantages described above in different lateral positions along the y axis 116 and along the z axis 118 at different heights. These different positions along the y and x axis 116 can be adopted, for example, by a desired gear change which is brought about by a user of the bicycle.

At the same time, in this exemplary embodiment shown, the roller element 108 can also be designed as one-piece or multi-piece. For example, the roller element 103 can consist of two or three parts, wherein respectively one part provides a different diameter of the regions 200 to 202. It is furthermore possible that the form of the roller element comprises a conical shape so that a continuous spectrum of diameters is provided for guiding the chain.

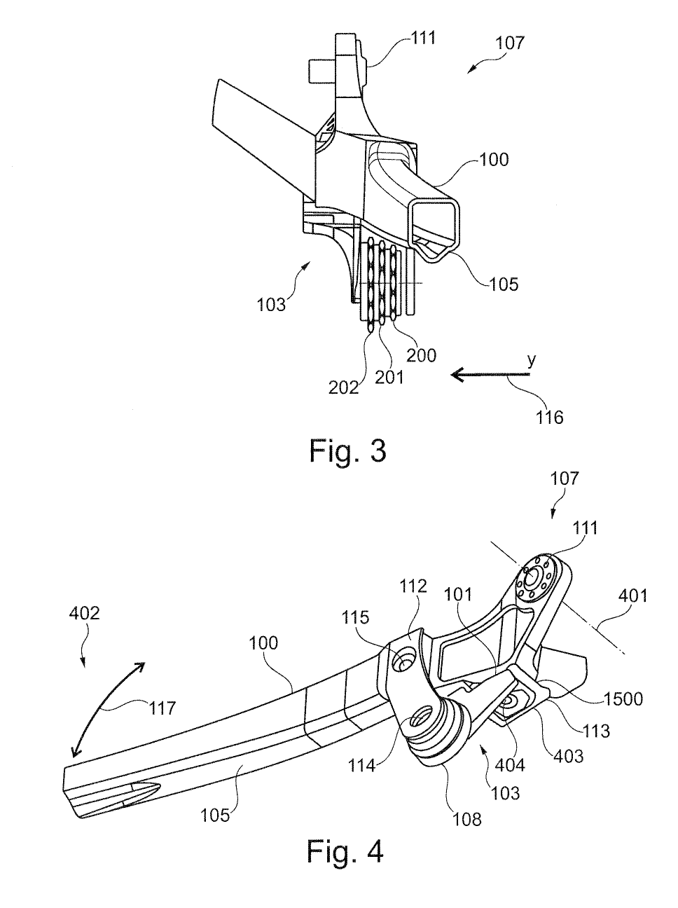

FIG. 3 shows the exemplary embodiment of FIGS. 1 and 2 in a rear view. In other words, this shows a chain guide system 107 having a chain stay 100 on which at the receiving device 101 the chain guide 103 is adjusted, positioned and fixed on the underside 105 of the chain stay. In this case, the different regions 200 to 202 having different diameters are shown. The lateral direction or y direction 116 is also shown in FIG. 3.

According to an exemplary embodiment of the chain stay not shown in detail, the receiving device comprises a guide element and at least one hole, the guide element making it possible to push the chain guide onto the chain stay; and the hole making it possible to fix the chain guide in a pushed-on state.

According to a further exemplary embodiment (likewise not shown in detail), the guide element makes it possible to achieve a two-dimensional alignment of a chain guide during the fastening of the chain guide.

FIG. 4 shows another exemplary embodiment of the invention comprising a chain guide system 107 having a chain stay 101 and a chain guide 103. Shown in this case is the axis of rotation 401 of the rear wheel swing arm 402 which has the chain stay 100 as a component. A movement 117 of the chain stay is thus possible by means of the swing arm bearing 111. In this exemplary embodiment of the invention the chain guide 103 comprises the connecting element 113, the roller element 108, the guide plate 112 with the openings 114 and 115. The receiving device 101 of the chain stay thereby forms a region which has a particular contour and a bore for receiving the connecting element. These are described in detail in FIG. 7.

In FIG. 4, as a result of the mounted state of the chain guide, the receiving device 101 is covered by the angled rectangular region 403 of the connecting element 113. In this case, if desired, this angled and rectangular region 403 can form a form-locking fit with the receiving device 101. Furthermore, this angled rectangular region 403 of the chain guide has a bore 404 which is brought to overlap with another bore 400 (not shown) in the chain stay during the alignment at the receiving device 101. Following an exemplary orientation of the roller element 108 at an appropriate angle by two-dimensional displacement of the connecting element 113 with respect to the receiving device 101, a fixing can then be accomplished.

It should explicitly be noted that the region of the receiving device shown covered so far due to the mounted position of the chain guide on the chain stay is, however, shown clearly as an example in FIG. 7.

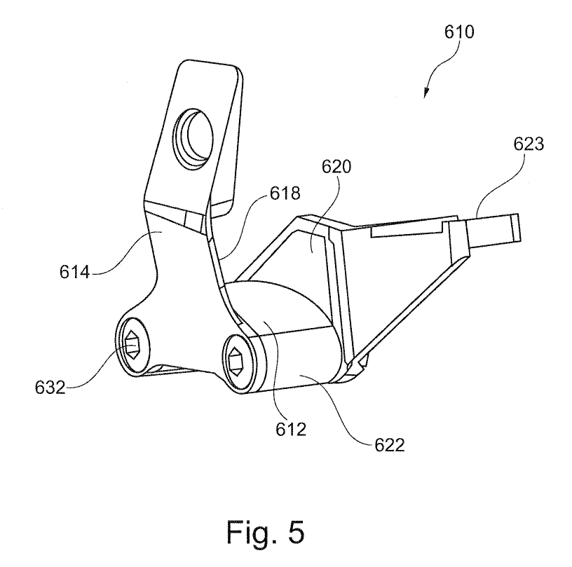

FIG. 5 shows a further exemplary embodiment of a chain guide 610 in which a sliding element 612 is provided as a chain guiding device. The chain guide 610 has a holding device 614 for fastening to a chain stay (not shown in detail in FIG. 5) according to one of the preceding exemplary embodiments.

For example, the sliding element 612 has a saddle-shaped sliding surface 616 which is configured in a such a manner that a chain can rest thereon and during a pedalling movement can slide in a low-friction manner on the surface. The saddle surface 616 is delimited laterally by two wall regions 618, 620. The front and rear edges of the saddle surface 616 are configured with rounded transitions 622.

One of the wall regions 618, for example, forms a region of the holder 614. The opposing region is also configured as a holder in order to be in contact with the chain stay 616 at a second position, for example, with a lug 623 inserted into a receptacle.

The opposing wall can, however, also be configured as merely a stop or guide wall, i.e. the chain guide is only fixed at one point on the chain stay which, however, is not shown in detail.

The sliding element guides the chain, in particular during lateral movements of the chain caused by a derailleur gear, within a desired positional range which is defined by the saddle surface.

The sliding element 612, for example, has a continuous surface which, in the mounted state when the bicycle is upright, runs horizontally in the lateral direction, i.e. in the Y direction or perpendicular to the direction of tension of the chain.

The sliding element 612 is configured in such a manner that in response to a lateral position change of the chain as a result of a derailleur gear with regard to the guidance of the chain it is possible to react in such a manner that the desired guidance of the chain is achieved in any lateral position of the chain. The chain is thus held in any operating state in the desired position or within the positional range.

According to an embodiment not shown further, the sliding surface is configured to be inclined. However, the sliding surface could also be configured with shoulders or steps, wherein the steps can be configured to be horizontal and/or inclined. For example, three steps are provided. For example, the three steps are configured to be horizontal. In another example, the steps are all configured to be inclined, wherein the inclination can be configured to be the same or of varying extent. In another example, the middle step is configured to be horizontal and the two outer steps are configured to have the same or different inclination. At the same time, a gradation can be configured to be the same or different. Intermediate steps are also possible to support a change of the chain from one partial region to the next.

The sliding surface, whether stepped or not, whether inclined or not, is preferably configured in such a manner that the chain is guided as far as possible in a region which corresponds with the respective front chain wheel used.

The sliding element 612 is fastened in the holder 614 in such a manner that it can easily be exchanged, for example, by means of screw connections 632. Instead of two screws, one or more than two screws can also be provided. For example, different sliding elements can also be inserted in the same holder, depending on the area of application and desired chain guidance.

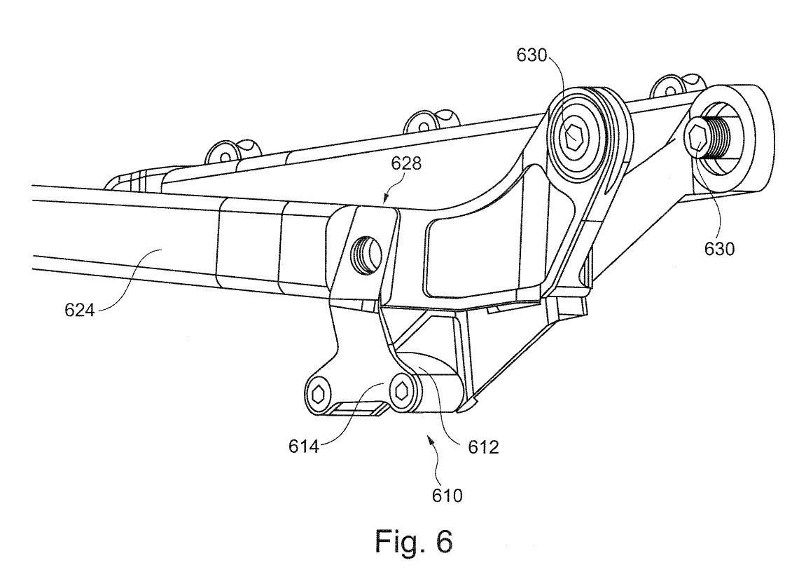

FIG. 6 shows the chain guide 610 from FIG. 5 in connection with a chain stay 624 which substantially corresponds to the previous exemplary embodiments of a chain stay. The chain guide is fastened with the holder 614 on the chain stay by means of a fastening device 626 on a receiving device 628 of the chain stay, for example, by means of a screw connection.

For example, the fastening on the chain stay is provided laterally.

According to another embodiment, the receiving device is provided on the underside of the chain stay.

As can be seen, the chain stay comprises a chain stay of a spring-mounted bicycle rear section which is pivotally articulated to the frame, as indicated by articulation points 630.

FIG. 7 shows a section 500 of a chain stay 100 as described, for example, in FIGS. 1 to 4. In this case, the receiving device 101 which here comprises a cubic shape with flattened corners and edges is shown in a detailed view. However, other geometrical shapes of the receiving device are also possible. The receiving device also has a hole 400 by which means the previously described connecting element 113 of the chain guide 103 can be fastened on the chain stay 100.

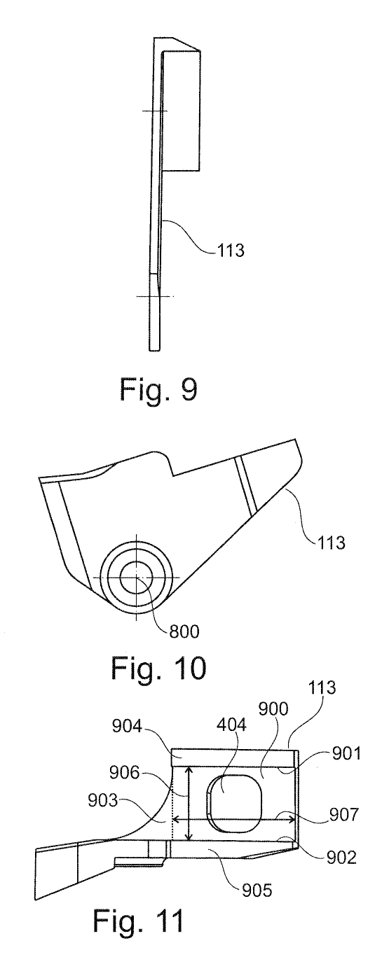

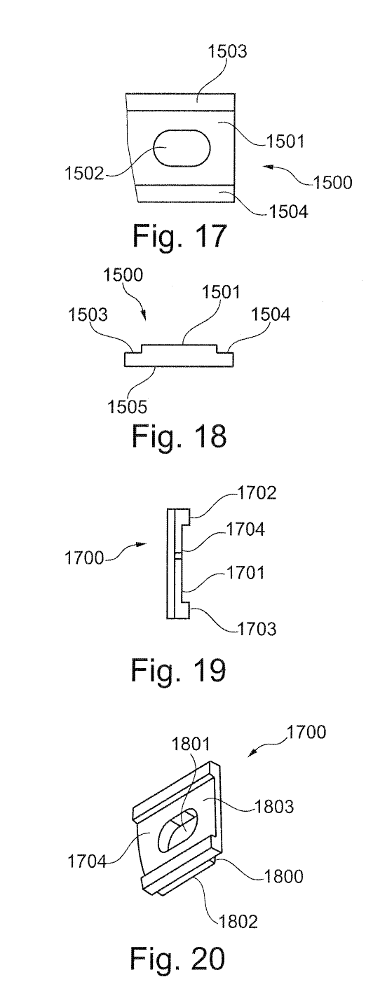

In other words, the receiving device 101 is formed by the region of the chain stay which comprises the guide element 106 and the bore 400. As a result of the edge profile of the different outer edges of the guide element 106, the connecting element described in detail in FIGS. 9 to 13 can also be used, for example, in combination with an intermediate plate shown in FIGS. 18 to 20 which is used to orient and align the chain guide with a roller element on the guide element 106. In this case, the alignment can be effected along the two axes 501 and 502 shown here in two-dimensional manner.

It is furthermore possible that the connecting element 106 is adapted in its external shape to the intermediate plate 1500 (see FIGS. 17 to 20) in such a manner and/or to the connecting element 113 (see FIGS. 9 to 13) in such a manner that a form-locking fit is obtained. However, a partial form-locking fit between these said elements is also possible.

FIG. 8 shows the guide plate 112 with the two openings 114 and 115. In this case, for example, a roller element 108, which in this and in any other exemplary embodiment of the invention can also be designated as a guide roller, can be fastened at the opening 114 and brought into communication with the connecting element. As shown in FIG. 4, the opening 115 is suitable for fixing the chain guide with an additional fixing on the chain stay 100.

FIGS. 9, 10 and 11 each show different views of the connecting element 113 which is designed for attachment of a roller element 108 (not shown here) in particular on the receiving device of the chain stay. In this case, FIG. 10 shows the opening 800 by which means the roller element can be fixed on the connecting element 113 in combination with, for example, a screw. It can also be clearly seen in FIG. 11 that the surface 900 of the connecting element 113 which is shown is a relief-type surface. In this case, a recessed region 903 can be seen which is lowered compared with the outer edge regions 904 and 905. At the same time, the transition edges 901 and 902 are designed as right-angled but can also be designed as not right-angled. Furthermore, an opening 404 is shown.

In combination with the previously described FIG. 7, it now becomes clear that the connecting element 113 can be pushed, for example, onto the guide element 106 shown in FIG. 5. In this case, the dimensions of the guide element 106 and the surface 900 can be adapted to one another in such a manner that a tight fit is obtained. However, it is also possible for the width 906 of the recessed region 903 and the length 907 of the recessed region 903 to be adapted with respect to the dimension of the guide element 106 (not shown) in such a manner that a two-dimensional alignment of the guide element and therefore of the roller element attached thereon is made possible. In other words, the two elements have some play which allows a two-dimensional alignment along the axes 501 and 502 shown in FIG. 7. It should also be noted that in addition to the chain guide just described which comprises the connecting element 113, an intermediate plate 1500 can also be used for the alignment. In this case, for example, a form-locking fit can be obtained between the intermediate plate 1500 and the surface 900. However, a non-form-locking design is also possible to allow a similar two-dimensional alignment of the intermediate plate inside the recessed region 903. The opening 404 shown in FIG. 11 can in this case be aligned with the opening 400 in FIG. 7 and/or with the opening 1502 in FIG. 17 in order to then achieve a fixing of the entire chain guide by means of a fastening means.

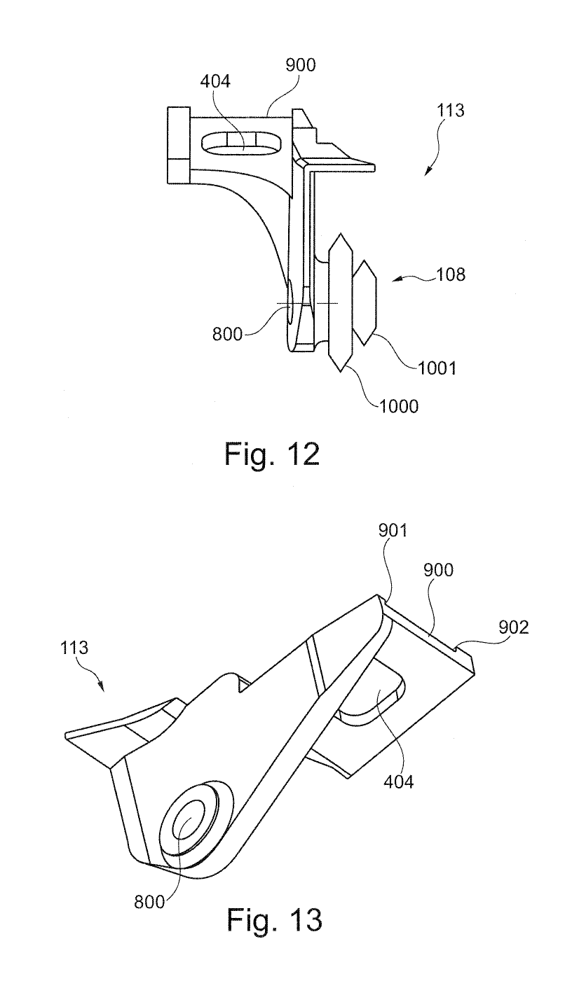

FIGS. 12 and 13 show further views of the connecting element 113. In this case, in a rear view of the connecting element 113 FIG. 12 shows the opening 404 which is located inside the lowered region 900. Also shown is the opening 800 of the connecting element 113 which allows a fixing of the roller element 118 on the connecting element. In this case, the connecting element is part of another exemplary embodiment of the invention. As an example, it is shown that the roller element can also be designed as two-piece, a first under-roller element 1000 and a second roller element 1001 being shown. The two elements 1000 and 1001 each designed in one piece have different diameters.

FIG. 13 shows a perspective of the connecting element 113 from a lower observation angle. Shown here is the opening 800 for attachment of a roller element and the opening 404 which, during alignment of the connecting element on the chain stay (not shown) is aligned with the opening 400, which, for example, can be designed as a thread. It can again be clearly seen that the lowered region 900 is delimited by two edges 901 and 902 running at right angles. This provides some clearance for alignment for the attachment of the connecting element 113 on the guide element 116.

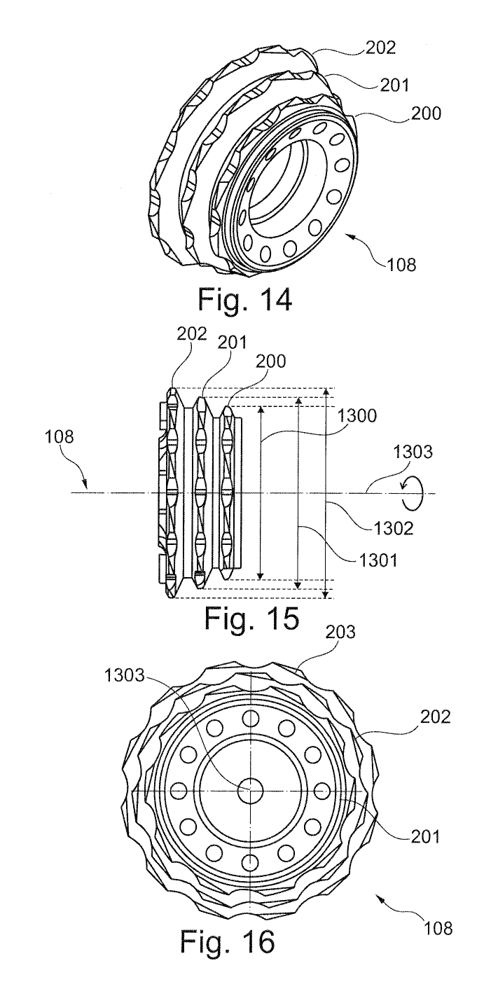

FIG. 14 shows an oblique view of the roller element 108 in which it can be clearly seen that the roller element comprises a first region 200, a second region 201 and a third region 202, the regions each having different diameters. This exemplary embodiment of the roller element can be designed in one piece or as multi-piece.

As can be seen in FIG. 14, the roller element can have three different diameters (1300, 1301, 1302), respectively one diameter of the roller element corresponding with respectively one position of the chain on one of three chain wheels.

FIG. 15 shows a side view of the roller element 108 with the three different regions 200, 201 and 201 wherein the first region 200 has a first diameter 1300, the second region 201 has a second diameter 1301 and the third region 202 has a third diameter 1302. In this case, the three diameters are of different size. The three regions are disposed concentrically about an axis of rotation 1303 of the roller element.

FIG. 16 shows a front view of the roller element 103 with the three different regions 201 to 203. Further, the axis of rotation 1303 is shown.

FIG. 17 shows an intermediate plate 1500 having a first elevated region 1501 which has a centred opening 1502. Located laterally thereto are two regions 1503 and 1504 which are offset at right angles. This can be seen clearly in the cross-sectional view of FIG. 18 in which the flat region 1501 is shown elevated compared with the flat regions 1503 and 1504. The intermediate plate 1500 also has a flat rear wall 1505.

FIG. 19 shows another exemplary embodiment of an intermediate plate 1700 in cross-section. In this case, this intermediate plate has a front surface (1704) which is configured to be U-shaped. In addition to a recessed region 1701, this has two elevated regions 1702 and 1703 at right angles thereto. This intermediate plate is shown in a perspective view in FIG. 20 in which an opening 1801 can further be identified. It is furthermore clear in FIG. 20 that the surface 1704 provides a guide channel 1803 which, for example, can be combined with the guide element 106 shown previously in FIG. 7 which is provided by a chain stay and by the receiving device 101. This can lead to an improved alignment of the chain guide.

It is further shown that a right-angled elevated region 1802 is disposed on the back 1800. This elevated region 1802 on the back of the intermediate plate 1700 can, for example, be introduced into the previously shown guide channel of the connecting element 113 (not shown) which guide channel is provided, for example, in FIG. 11, by the lowered region 903. By means of this combination of the intermediate plate 1700, the connecting element 113 and the receiving device 101 with the guide element 106 (FIG. 7), it can be achieved that a fine adjustment of the chain guide and a two-dimensional orientation of the chain guide at an appropriate angle can be made before fixing.

FIG. 21 shows a bicycle 1907 having a rear section 1900 which inter alia has a chain stay 100. Also shown is the bottom bracket casing 1901 and the region 1902 of a rear dropout. It can be clearly seen that the chain stay 100 extends between this region 1902 and the bottom bracket casing 1902. In this contest, it should be explicitly noted that the region in which the receiving device according to the invention is located is situated to the right of the end of the chain stay 1909 in FIG. 21. The chain stay also has a receiving device 101 which is located in the front region near the bottom bracket casing. In this case, it can be clearly seen that the distance 1903 between the receiving device 101 and the centre of the bottom bracket is clearly shorter than the distance 1904 between the rear wheel 1905 and the centre of the bottom bracket. In other words, in this exemplary embodiment of the invention the chain guide is attached in a region of the chain stay in which the chain guide (not shown here) is protected from mechanical influences by the chain stay and the chain wheel 1908 shown here as an example. This may mean a gain in safety for the user. Furthermore, as a result of the very close positioning of the chain guide on the chain wheel 1908, it is ensured that the chain is held in the desired position by means of the chain guide even during a back pedalling of the user. An undesirable lateral movement and an undesirable gear change of the chain caused thereby can thus be avoided. This can mean a gain in safety since, for example, slips can be avoided.

It can furthermore be seen that during a movement carried out by the rear section 1900 and depicted by the arrows 117, the chain guide which is disposed on the chain stay executes this movement in the same way as the chain stay. Thus, with the chain guide system which comprises the chain stay 100 with the receiving device 101 and the chain guide 103 not shown here, the distance from a roller element of the chain guide to the chain stay can be kept almost constant and permanent contact of the chain and the roller element can be achieved regardless of the dynamics of the rear section.

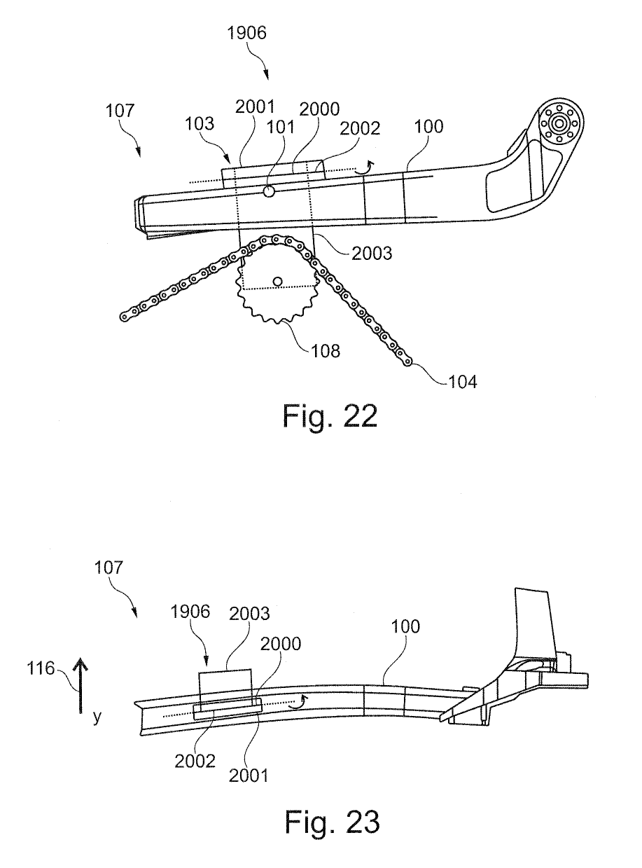

FIG. 22 shows another chain guide system 107 according to a further exemplary embodiment of the invention. Shown in this case is a chain stay 100 which is disposed in a central region 1906 of the chain stay. In this exemplary embodiment the receiving device can be designed, for example, as an opening 101. In this exemplary embodiment, the chain guide 103 comprises a pivot link 2000, wherein the guidance of the chain during a movement of the chain caused by a derailleur gear is effected by a movement of the chain guide 103 around the pivot link 2000.

In this case, the pivot is designed as an axis of rotation 2002 and the chain guide comprises a pivotable arm 2003 which is pivotable about this axis of rotation. In this exemplary embodiment the chain guide further comprises a roller element 108 which is fixed on the pivot aim. In this case, this roller element can have the aforesaid properties of a roller element.

FIG. 23 shows the chain guide system 107 from FIG. 22 from a bird's eye perspective wherein it can be clearly seen in this view that a lateral movement of the chain takes place in the y direction 116. The pivotable arm 2003 thus rotates about the axis of rotation 2002 which is attached in a mechanical casing 2001 for accommodating the axis of rotation on the chain stay 100. This casing can, for example, be screwed to the chain stay by means of the receiving device 101 which can comprise a thread. However, other types of attachment are also possible. As a result of this movably mounted attachment of the pivotable arm 2003 in the central region of the chain stay 1906, during a movement of the chain in the y direction caused, for example, by a derailleur gear, it is possible for the arm to track this movement and achieve a desired guidance of the chain. In this case, for example, in this and in any other exemplary embodiment, the chain guide can be adjusted by means of the chain roller in such a manner that an additional tension is produced on the chain to prevent the chain from falling from the chain wheels or the sprocket.

1. A chain stay on a bicycle rear section, said chain stay comprising:
at least one receiving device;
wherein the chain stay extends between a bottom bracket casing of the bicycle and a region of a rear dropout of the bicycle;
wherein the receiving device is part of the chain stay; and
wherein the receiving device is designed for fastening a chain guide on the chain stay.

2. The chain stay according to claim 1, wherein the receiving device is designed in such a manner that when fastening the chain guide on the chain stay, a guidance of the chain is effected during a movement of the chain caused by a derailleur gear.

3. The chain stay according to claim 1, wherein the receiving device is disposed on an underside of the chain stay.

4. The chain stay according to claim 1, wherein the receiving device comprises a guide element and at least one bore;
wherein the guide element makes it possible to push the chain guide onto the chain stay; and
wherein the bore makes it possible to fix the chain guide in a pushed-on state.

5. The chain stay according to claim 4, wherein the guide element allows a two-dimensional alignment of the chain guide when fastening the chain guide.

6. The chain stay according to claim 1, wherein a first distance between the receiving device and the bottom bracket casing is smaller than a second distance between a rear wheel and the bottom bracket casing.

7. The chain stay according to claim 1, wherein the receiving device is disposed in a central region of the chain stay between the bottom bracket casing of the bicycle and the region of a rear dropout.

8. A chain guide for guiding a bicycle chain and for attachment to a chain stay on a bicycle rear section, said chain guide comprising:
a chain guiding device which is configured in such a manner that during movements of the chain caused by a derailleur gear, a chain is guided by the chain guiding device.

9. The chain guide according to claim 8, wherein the chain guiding device comprises a sliding element which is configured in such a manner that during movements of the chain caused by a derailleur gear, a chain is held within a desired positional range by the sliding element.

10. The chain guide according to claim 8, wherein the chain guiding device comprises a roller element;
wherein the roller element has at least one first region having a first diameter and a second region having a second diameter;
wherein the first and the second diameters are different;
wherein the first region is designed for guidance of the chain in a first position of the chain on chain wheels of the bicycle;
wherein the second region is designed for guidance of the chain in a second position of the chain on the chain wheels of the bicycle; and
wherein a change of the chain from the first into the second position is caused by a derailleur gear.

11. A chain guide system comprising a chain stay according to claim 1, said chain guide system further comprising:
a chain guide for guiding a chain; wherein the chain guide comprises a chain guiding device which is configured in such a manner that during movements of the chain caused by a derailleur gear, the chain is guided by the chain guiding device.

12. The chain guide system according to claim 11, wherein the chain guide comprises a sliding element which is configured in such a manner that during movements of the chain caused by a derailleur gear, a chain is held within a desired positional range by the sliding element.

13. The chain guide system according to claim 11, wherein the chain guide comprises a roller element; and
wherein the roller element is designed in such a manner that during movements of the chain caused by a derailleur gear, the chain is held in a desired position by the roller element.

14. The chain guide system according to claim 13,
wherein the roller element has at least one first region having a first diameter and a second region having a second diameter;
wherein the first and the second diameters are different;
wherein the first region is designed for guidance of the chain in a first position of the chain on chain wheels of the bicycle;
wherein the second region is designed for guidance of the chain in a second position of the chain on the chain wheels of the bicycle; and
wherein a change of the chain from the first into the second position is caused by a derailleur gear.

15. The chain guide system according to claim 14, wherein the different diameters are adapted to diameters of the chain wheels of the bicycle in such a manner that a variation of a wrap-around angle of the chain around the roller element is minimised in the event of changes in the position of the chain on the chain wheels.

16. The chain guide system according to claim 11, wherein the roller element has three different diameters; and
wherein in each case one diameter of the roller element corresponds to respectively one position of the chain on one of three chain wheels.

17. The chain guide system according to claim 11, wherein the chain guide has a pivot link; and
wherein the guidance of the chain during a movement of the chain caused by a derailleur gear is effected by a movement of the chain guide around the pivot link.

18. The chain guide system according to claim 17,
wherein the pivot link is an axis of rotation;
wherein the chain guide comprises a pivotable arm;
wherein the arm comprises a roller element; and
wherein the guidance of the chain during a movement of the chain caused by a derailleur gear is effected by a pivoting movement of the arm.

19. A bicycle having a rear section on which a chain stay according to claim 1 is disposed.
